(19) United States
(12) Patent Application Publication
(10) Pub. No.: US 2009/0177715 A1
(43) Pub. Date: Jul. 9, 2009

(54) DATA BACKUP DEVICE AND SYSTEM WITH THE SAME

(75) Inventor: Yang Lu, Shijr City (TW)

Correspondence Address: KIRTON AND MCCONKIE, 60 EAST SOUTH TEMPLE,, SUITE 1800, SALT LAKE CITY, UT, 84111, US

(73) Assignee: ATEN INTERNATIONAL CO., LTD., Shijr City (TW)

(21) Appl. No.: 11/969,549

(22) Filed: Jan. 4, 2008

(51) Int. Cl. G06F 12/16; G06F 17/30

(52) U.S. Cl. 707/204; 707/E17.01

(57) ABSTRACT

A data backup device for providing backup of user data for a plurality of data management devices and a system having the same are disclosed. The system includes at least one data management device for transferring user data via a network and the data backup device connected to the data management device(s) via the network. The data backup device has a user database for storing the user data transferred via the network from the data management device and a utility for directing the user data from the data management device to be stored in the user database. By using the system, backup of user data from the data management devices can be provided, in addition, the user data backup can be picked to use under different conditions by using different interfaces such as FTP, socket and trigger interfaces.

### TECHNICAL FIELD OF THE INVENTION

The present invention relates to data backup, more particularly, to a system for providing user data backup and a data backup device used in the system.

### BACKGROUND OF THE INVENTION

Nowadays, it is very convenient that an administrator may manage user data from remote user devices via network. To achieve such a remote management for user data, a data management device is required. The data management device is a relay-like equipment which has a plurality of serial ports. Each port of the data management device is connected with a user device such as a personal computer (PC), a router, a probe, a thermometer or the like. Herein, the user device can be any device providing user data. The data management device collects the user data and converts the user data into a data form so that the user data can be transferred over the network. For example, the data management device packs and converts the user data into network-acceptable data packages. The data management device then transfers the data packages to a remote console via Internet, for example.

As mentioned, user data from the user device are transferred to the console through the data management device. Usually, the data management device contains a buffer with a very limited capacity, 64K, for example. Accordingly, the data management device will discard the user data once the user data is used or transmitted. That is, the data management device will not keep any backup of the user data. However, there can be many situations that certain pervious communication context is required to be recurred. If a certain previous context is to be reproduced, the previous user data is necessary. Furthermore, the user data might be lost after the user data is transferred out of the data management device. For example, an application executed at the console receives and handles the user data transferred from the data management device. If the application aborts or fails, the user data will be lost. Therefore, there is a need to provide backup for the user data.

### SUMMARY OF THE INVENTION

The present invention is to provide a data backup device for providing backup of user data for a plurality of data management devices and a system comprising the data backup device. By using the system, backup of user data from the data management devices can be provided, in addition, the user data backup can be picked for various applications under different conditions.

In accordance with the present invention, the system for providing user data backup comprises at least one data management device for transferring user data via a network and a data backup device connected to the data management device(s) via the network. The data backup device comprises a storage for storing the user data transferred via the network from the data management device and a utility for directing the user data from the data management device to be stored in the storage in a specific format, such as a binary file.

### BRIEF DESCRIPTION OF THE DRAWINGS

FIG. 1 is a schematic illustration showing a system for providing user data backup in accordance with the present invention;

FIG. 2 is a schematic illustration showing an application example of the system in accordance with the present invention;

FIG. 3 is a schematic illustration showing another application example of the system in accordance with the present invention; and

FIG. 4 is a schematic illustration showing a further application example of the system in accordance with the present invention.

### DETAILED DESCRIPTION OF THE INVENTION

The present invention will be described in detail in conjunction with the above appending drawings.

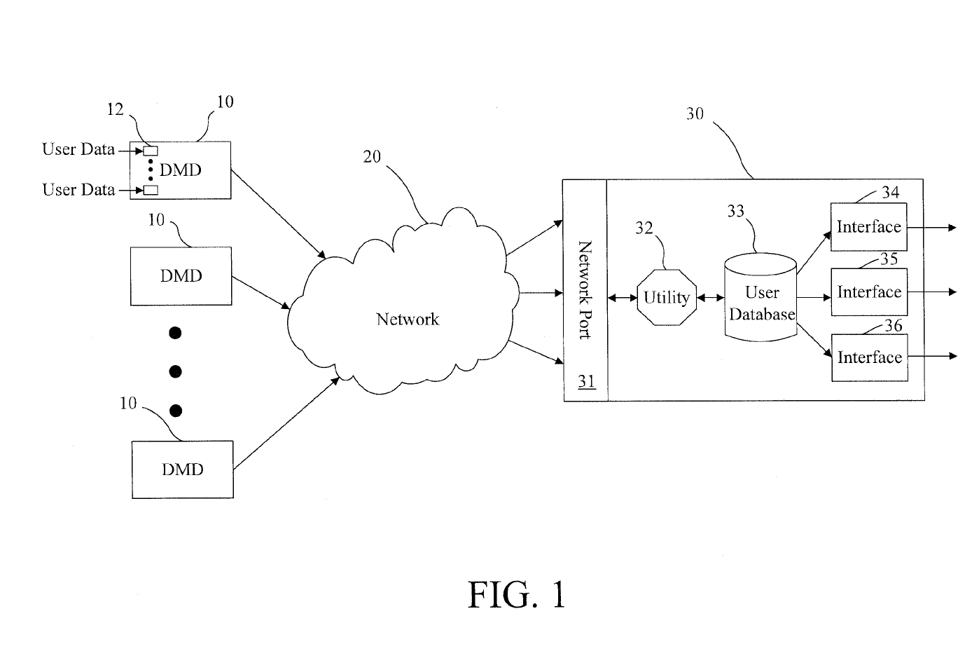

FIG. 1 is a schematic illustration showing a system for providing user data backup in accordance with the present invention. As shown, in the system, there may be a plurality of data management devices (DMD) 10. Each data management device 10 has multiple serial ports 12, for example, 8, 16 or even 32 ports. The data management device 10 is connected with user devices (not shown) such as personal computers, routers, probes, thermometers, or the like to receive user data via the ports 12. The data management device 10 receives the user data from the user device, then converts the user data into a form which is acceptable by network communication. That is, the data management device 10 packs the user data from the user devices into data packages which can be transferred over a network 20 (e.g. Internet).

In accordance with the present invention, the system includes a data backup device 30, which can be implemented by means of a personal computer, for example. The data backup device 30 listens to receive the user data transferred over the network 20 by a network port 31, which is a UDP (User Datagram Protocol) or TCP (Transmission Control Protocol) port.

The data backup device 30 has a utility 32 and a storage such as a user database 33. The utility 32 adds identification information such as a network address of the source user device and/or network address of the data management device as well as timestamp to the user data, and then stores the user data to the user database 33 for backup. Before being stored into the user database 33, the utility 32 may formats the user data into a proper form such as a binary file. In one example, user data from one same data management device 10 are stored in one binary file. In addition, the utility 32 can encrypt the user data. The utility 32 can also classify the user data according to the source attributes, for example.

The data backup device 30 further has at least one interface to provide a path for a user to get the backup user data. In the present embodiment, the data backup device 30 has three interfaces 34, 35, 36, which are respectively FTP (File Transfer Protocol) interface, Socket interface and Trigger interface. The interfaces are constructed based on TCP (Transmission Control Protocol)/IP (Internet Protocol), and are implemented in software. For example, these three different interfaces 34, 35, 36 can be implemented by three different processes or threads, which can be built in the utility 32. The details of the interfaces will be further described later. It is noted that these three interfaces are described herein for the sake of exemplarity rather than limitation. Other types of interfaces can also be used for providing different paths for users to get the backup user data stored in the user database 33 under various situations.

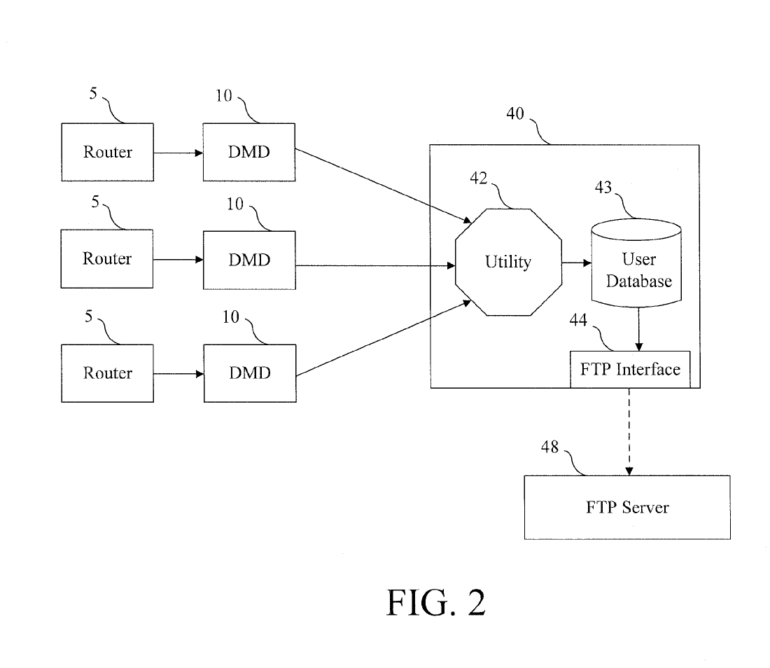

FIG. 2 is a schematic illustration showing an application example of the system in accordance with the present invention, in which a data backup device 40 of the system has an FTP interface 44. User data from routers 5 are sent to a data backup device 40 by data management devices 10, respectively, via a network (not shown). A utility 42 of the data backup device 40 stores the coming user data into a user database 43 as binary files. As mentioned, the data backup device 40 has the FTP interface 44. When it is required to transfer user data to a remote FTP server 48, a connection is established between the FTP server 48 and the FTP interface 44, and the FTP interface 44 picks the required user data from the user database 43 and transfers the same to the FTP server 48.

The FTP interface 44 is used when the user data is to be transferred in a non-real time manner. For example, the FTP interface 44 checks the files in the user database 43 in a polling mode to see if there is any newly coming user data. If there is new user data, the FTP interface 44 connects to the remote FTP interface 48, inputs username and password automatically to transfer the new user data to the FTP server 48. In a word, the FTP interface 44 transfers non-real time user data files from the data backup device 40 to the FTP server 48 automatically.

In one example, if a user wants to know the performance of the three routers 5. The routers 5 generate performance reports and send the performance reports to the remote data backup device 40 by the data management device 10 over the network. In one example, each router 5 may generate the performance report every five minutes. That is, the data backup device 40 receives three new reports from the three routers 5 every five minutes. These three reports contain the performance data of the respective routers 5 for the last five minutes. In the meanwhile, the utility 42 has a timer (not shown). The timer notifies the FTP interface 44 to check if there are newly coming data files every five minutes. If so, the FTP interface 44 establishes the connection to the FTP server 48 and transfers the contents of the new data files to the FTP server 48.

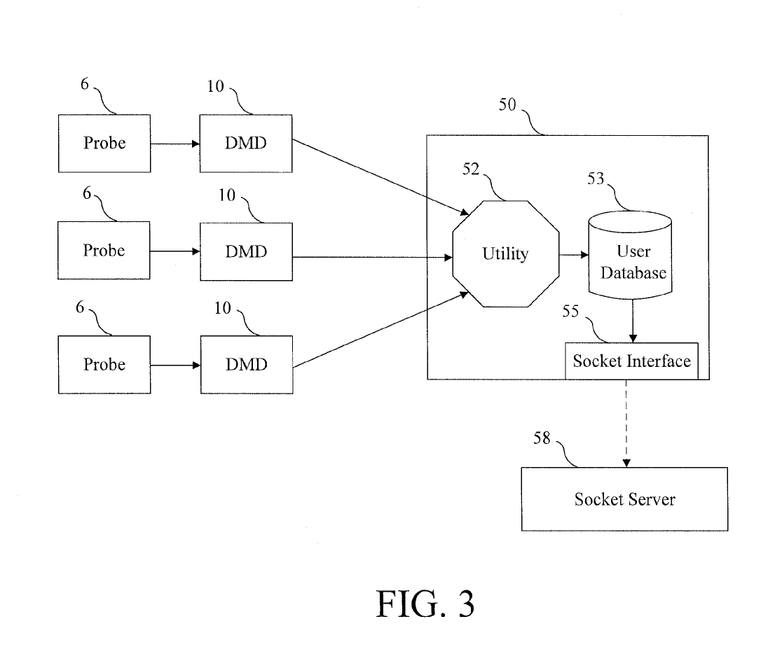

FIG. 3 is a schematic illustration showing another application example of the system in accordance with the present invention, in which a data backup device 50 of the system has a socket interface 55. The socket interface 55 is used when the user data is required in a real time mode or urgent situation. As shown, the socket interface 55 is connected to a socket server 58. It is noted that the connection between socket 55 and the socket server 58 is always maintained to allow data flowing therethrough. That is, the communication tunnel between the socket interface 55 and the socket server 58 keeps to be connected even if there is no user data coming. Once a new user data enters a user database 53 of the data backup device 50, that is, a utility 52 stores newly coming user data to the user database 53, the socket interface 55 will pass the new user data to the socket server 58 immediately. In this example, there are three probes 6, each of which samples medical data such as blood pressure, heartbeat or the like from a patient, sending user data (i.e. the medical data) to the respective data management devices 10. The data management devices 10 pass the user data to the data backup device 50. The utility 52 stores the user data into the user database 53 for backup. In addition, the utility 52 notifies the socket interface 55 to transfer the newly coming user data to the socket server 58 without any delay. By this way, a remote doctor may know the conditions of the patients well by the socket server 58 in real time, for example.

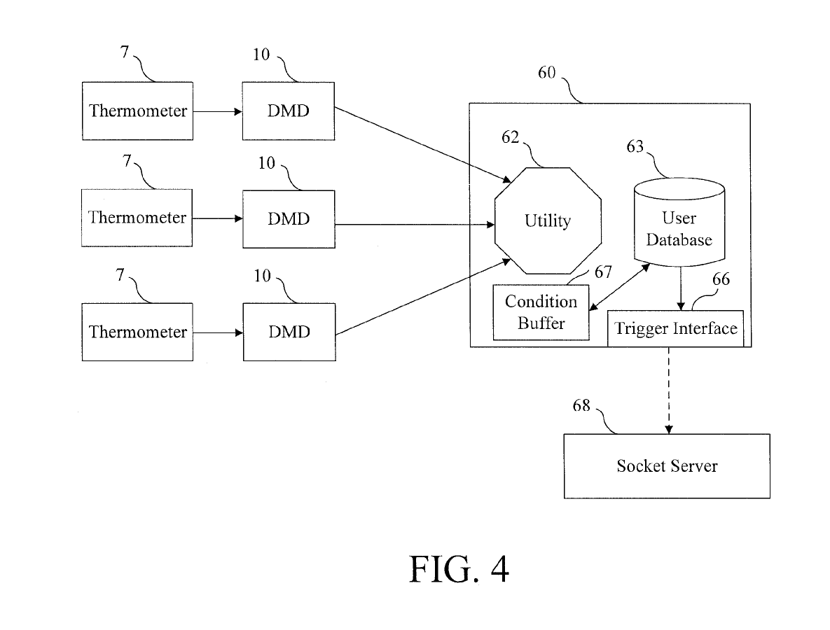

FIG. 4 is a schematic illustration showing another application example of the system in accordance with the present invention, in which a data backup device 60 of the system has a trigger interface 66. The trigger interface 66 can be deemed as a special kind of the socket interface. In the viewpoint of communication, the trigger interface 66 operates in a similar way as that of the socket interface 55 of FIG. 3. That is, the trigger interface 66 keeps connection with a remote socket server 68. The different between the trigger interface 66 and the socket interface 55 is that the trigger interface 66 sends the user data to the socket server 68 only when one or more predetermined conditions are satisfied. That is, the trigger interface 66 has a function as a filter. The trigger interface 66 only transfers user data conforming to some standard(s). To filter user data, the data backup device 60 further as a condition buffer 67 to save configuration data of trigger conditions.

In the example shown in FIG. 4, there are three thermometers 7 disposed in different server rooms to detect the room temperatures therein. The respective thermometers 7 transmit the temperature data as user data to the data backup device 60 through the data management devices 10 over the network. A utility 62 stores the data into a user database 63. The trigger interface 66 picks any new user data and compares the new user data with configuration data stored in the condition buffer 67 to check whether the temperature data meets the trigger condition defined by the configuration data or not. If so, the trigger interface 66 passes the temperature data to the socket server 68. For example, the trigger condition is an upper limit of 50° C. If there is any temperature data exceeds such a limit, the temperature data will be sent to the socket server 68. By this way, a user at the socket server end can find the abnormal high temperature at once.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A system for providing user data backup, the system comprising:
a data management device for transferring user data via a network; and
a data backup device connected to the data management device via the network, comprising:
a storage for storing the user data transferred via the network from the data management device; and
a utility for directing the user data from the data management device to be stored in the storage in a specific format.

2. The system as claimed in claim 1, wherein the utility formats the user data and stores the formatted user data into the storage.

3. The system as claimed in claim 2, wherein the utility converts the user data from the data management device into a binary file and stores the binary file into the storage.

4. The system as claimed in claim 1, wherein the utility encrypts the user data before storing the user data into the storage.

5. The system as claimed in claim 1, wherein the user data is stored as a disk file.

6. The system as claimed in claim 1, wherein the user data is classified before being stored into the storage.

7. The system as claimed in claim 1, wherein the utility adds at least one selected from a group consisted of identification of the data management device, network address of the data management device and timestamp to the user data before storing the user data into the storage.

8. The system as claimed in claim 1, wherein the data backup device further comprises an interface, the user data stored in the storage is transmitted to a remote server through the interface.

9. The system as claimed in claim 7, wherein the interface is an FTP interface, the FTP interface is connected to a remote FTP server in response to a request requesting for the user data, and the requested user data from the storage is transmitted to the remote FTP server through the FTP interface.

10. The system as claimed in claim 7, wherein the interface is a socket interface, the socket interface is connected with a socket server, the user data is transmitted to the socket server through the socket interface when the user data is stored into the storage.

11. The system as claimed in claim 7, wherein the interface is a trigger interface, the trigger interface is connected with a socket server, the user data is transmitted to the socket server through the trigger socket interface when the user data is stored into the storage and a predetermined condition is satisfied.

12. A data backup device connected to a data management device for transferring the converted user data via a network via a network, the data backup device comprising:
a storage for storing user data transferred via the network from the data management device;
a utility for directing the user data from the data management device to be stored in the storage in a specific format; and
an interface for the user data stored in the storage transmitting to a remote server.

13. The data backup device as claimed in claim 12, wherein the utility formats the user data and stores the formatted user data into the storage.

14. The data backup device as claimed in claim 13, wherein the utility converts the user data from the data management device into a binary file and stores the binary file into the storage.

15. The data backup device as claimed in claim 12, wherein the utility encrypts the user data before storing the user data into the storage.

16. The data backup device as claimed in claim 12, wherein the user data is classified before being stored into the storage.

17. The data backup device as claimed in claim 12, wherein the utility adds at least one selected from a group consisted of identification of the data management device, network address of the data management device and timestamp to the user data before storing the user data into the storage.

18. The data backup device as claimed in claim 12, wherein the interface is an FTP interface, the FTP interface is connected to a remote FTP server in response to a request requesting for the user data, and the requested user data from the storage is transmitted to the remote FTP server through the FTP interface.

19. The data backup device as claimed in claim 12, wherein the interface is a socket interface, the socket interface is connected with a socket server, the user data is transmitted to the socket server through the socket interface when the user data is stored into the storage.

20. The data backup device as claimed in claim 12, wherein the interface is a trigger interface, the trigger interface is connected with a socket server, the user data is transmitted to the socket server through the trigger socket interface when the user data is stored into the storage and a predetermined condition is satisfied.
